(19) United States
(12) Patent Application Publication
(10) Pub. No.: US 2024/0395521 A1
(43) Pub. Date: Nov. 28, 2024

(54) Method and Apparatus for Rapid Mass Spectrometric Calibration

(71) Applicant: Queen's University at Kingston, Kingston (CA)

(72) Inventors: Richard D. Oleschuk, Kingston (CA); Matthias Hermann, Kingston (CA); Prashant Agrawal, Kingston (CA)

(21) Appl. No.: 18/695,474

(22) PCT Filed: Sep. 26, 2022
(86) PCT No.: PCT/CA2022/051422

§ 371 Date: Mar. 26, 2024

Related U.S. Application Data
(60) Provisional application No. 63/248,707, filed on Sep. 27, 2021.

(51) Int. Cl. H01J 49/00; H01J 49/04

(52) U.S. Cl. CPC H01J 49/0009; H01J 49/0031; H01J 49/0431

(57) ABSTRACT

Rapid calibration of a quantitative analysis instrument such as a mass spectrometer is performed using a calibration chip surface having different sized surface energy traps (SETs) and a transfer chip surface having same sized SETs, wherein the SETs of each chip surface are substantially aligned when they are disposed face to face. The calibration chip is exposed to an analyte solution 5 such that different sized droplets adhere to the different sized SETs, and the transfer chip is exposed to a standard solution such that same sized droplets adhere to the same sized SETs. The chips are aligned face to face in a spaced relationship such that at least a portion of each droplet of the standard solution is transferred to the SETs of the calibration chip. The chips are then separated and the calibration chip is used to calibrate the quantitative analysis instrument by sampling the SETs.

### FIELD

The invention relates to methods and apparatus for calibrating quantitative analysis instruments. More particularly, the invention relates to discontinuous dewetting of hydrophobic/hydrophilic patterned surfaces to precisely deposit small liquid volumes on surfaces that can be used to rapidly calibrate instruments such as mass spectrometers.

### BACKGROUND

Quantitative analysis such as mass spectrometry requires calibrating the instrumental signal with a known amount of analyte. Regular calibrations are essential to ensure accurate results but can be very time consuming. For example, the International Union of Pure and Applied Chemistry (IUPAC) advises the use of at least six calibration standards that should be run as triplicates or more (Thompson, M., et al., Harmonized guidelines for single-laboratory validation of methods of analysis (IUPAC Technical Report). Pure Appl. Chem. 2002, 74:835-855). Calibration is typically conducted with several different sample concentrations or analyte amounts to both monitor and account for changes in signal response from the sample, matrix, and instrumental factors. The preparation of calibration standards can be lengthy and tedious, usually carried out by first carefully weighing analytical standards or certified reference materials followed by accurate dispensing in defined volumes and dilution. When conducting multi-analyte analysis, the calibration time is further exacerbated as instrument response is determined for each element or compound. The accuracy of a calibration is affected by both systematic and/or random errors that originate from a number of sources. Systematic errors are reduced by minimizing differences in the sample/calibration standard properties, conditions during calibration, and the use of internal standardization to correct for matrix effects. Different instrumental methods require more or less frequent calibration depending upon the stability and reproducibility of experimental conditions and method robustness. Liquid calibration solutions are prepared by dispensing appropriate amounts of a carefully prepared stock calibrant solution using an analytical balance or pipette (or a combination of both) followed by dilution of the analyte with the matrix solution.

### SUMMARY

According to one aspect of the invention there is provided a method for calibrating a quantitative analysis instrument, comprising: providing a calibration chip surface having a plurality of different sized surface energy traps (SETs) formed thereon; providing a transfer chip surface having a plurality of same sized SETs formed thereon; wherein the SETs of the calibration chip surface and the SETs of the transfer chip surface are substantially aligned when the calibration chip surface and the transfer chip surface are aligned face to face; exposing the calibration chip surface to a solution comprising an analyte such that different sized droplets adhere to the different sized SETs; exposing the transfer chip surface to a standard solution such that same sized droplets adhere to the same sized SETs; aligning the calibration chip and the transfer chip face to face in a spaced relationship such that the same sized droplets of the standard solution contact the SETs of the calibration chip and at least a portion of each droplet of the standard solution is transferred to the SETs of the calibration chip; and separating the calibration chip and the transfer chip and using the calibration chip to calibrate the quantitative analysis instrument by sampling the SETs with the quantitative analysis instrument.

In one embodiment, adhesion of droplets to SETS of the transfer chip and transfer of at least a portion of standard solution to SETs of the calibration chip is controlled according to a selected shape of the SETs of the transfer chip.

One embodiment comprises allowing the different sized droplets of the solution comprising the analyte to dry before aligning the calibration chip and the transfer chip.

In various embodiments, the quantitative analysis instrument may be for mass spectrometry, spectroscopy, or an electrochemical technique.

In one embodiment, the method may comprise sampling the SETs with a liquid microjunction-surface sampling probe (LMJ-SSP).

In one embodiment, the SETs of the calibration chip and the SETs of the transfer chip may be defined by regions of a hydrophilic substrate surrounded by a hydrophobic coating disposed on the hydrophilic substrate.

In one embodiment, the SETs of the calibration chip comprise a shape that is circular or spiral.

In one embodiment, the SETs of the transfer chip comprise a shape that is circular or a ring.

In one embodiment, the method may comprise using an alignment tool to align the calibration chip and the transfer chip face to face in a spaced relationship.

According to another aspect of the invention there is provided an apparatus for calibrating a quantitative analysis instrument, comprising: a calibration chip having a calibration surface comprising a plurality of different sized surface energy traps (SETs) formed thereon; a transfer chip having a transfer surface comprising a plurality of same sized SETs formed thereon; wherein the SETs of the calibration chip and the SETs of the transfer chip are substantially aligned when the calibration surface and the transfer surface are aligned face to face; and an alignment device that aligns the calibration chip and the transfer chip face to face in a spaced relationship such that material disposed on the SETs of the calibration surface contact droplets of a solution disposed on the SETs of the transfer surface.

According to embodiments, the calibration chip may be used to calibrate the quantitative analysis instrument by sampling the SETs of the calibration surface using the quantitative analysis instrument.

According to embodiments, the quantitative analysis instrument may be for mass spectrometry, spectroscopy, or an electrochemical technique.

In one embodiment, the mass spectrometer may comprise a liquid microjunction-surface sampling probe (LMJ-SSP).

In one embodiment, the SETs of the calibration chip and the SETs of the transfer chip are defined by regions of a hydrophilic substrate surrounded by a hydrophobic coating disposed on the hydrophilic substrate.

In one embodiment, the alignment device comprises a spacer that maintains the aligned calibration chip and the transfer chip face to face in the spaced relationship at a selected distance.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIG. 1A (left) is a photograph of a transfer chip and (right) is a photomicrograph showing a partial view of a surface energy trap (SET) of the transfer chip, according to one embodiment.

FIG. 1B (left) is a photograph of a rapid calibration chip (RCC) and (right) are photomicrographs showing partial views of 2.00 mm and 1.00 mm diameter SETs and a 0.25 mm diameter SET of the RCC, according to one embodiment.

FIG. 2A is a diagram of a setup used for testing rapid calibration and transfer chips, with insets showing an open port interface (OPI) operating in vortex and dome modes (upper right) and transfer and rapid calibration chip patterns (lower right), according to one embodiment.

FIG. 2B is a flow chart showing a sampling sequence for the OPI, according to one embodiment.

FIG. 3 is a plot showing impact of probe solvent dome contact on blank SETs, wherein caffeine was measured (m/z: 195.1/138.0, solid line) using an optimized sampling program (FIG. 2B) with a flow rate (dashed line) when an empty row of SETs was sampled; untreated areas and diameter of the SET that was sampled are indicated below the traces.

FIG. 4 is a plot showing calibration curves based on pipetting solution directly into the OPI using solvent flowrates of 80 μL/min (solid line), 110 μL/min (inset, dotted line) and by sampling calibration solutions from the rapid calibration chip using an optimized flow program (FIG. 2B) that switches between vortex (80 μL/min) and dome mode (150 μL/min) (dashed line).

FIG. 5 shows chromatograms of caffeine (195.1/138.0, solid line) and caffeine-d9 (204.1/144.1, dashed line) for a row of RCC SETs containing 100 pmol of caffeine and 10 pmol of caffeine-d9 sampled for the first time (top) and a second time (bottom).

FIG. 6A is a diagram showing a procedure for testing reproducibility of discontinuous dewetting of rapid calibration chips, according to one embodiment.

FIG. 6B shows a diagram (left) of a rapid calibration chip according to an embodiment having three rows of different sized SETs that were sequentially sampled (arrows), and corresponding data (right).

FIG. 6C shows extracted ion chromatograms for caffeine (195.1/138.0, solid line) and the internal standard caffeine-d9 (204.1/144.1, dashed line) for the RCC of FIG. 6B.

FIG. 6D is a plot showing calculated volumes of liquid that was deposited on SETs of the RCC of different sizes (FIG. 6B), shown symbolically as circles at the base of each bar, wherein error bars are based on triplicate measurements.

FIG. 7A is a diagram showing a procedure for liquid sample deposition on a rapid calibration chip followed by internal standard delivery to the RCC using a transfer chip, according to one embodiment.

FIG. 7B is a diagram showing an apparatus used to facilitate delivery of an internal standard from SETs of a transfer chip to SETs of an RCC, according to one embodiment.

FIG. 8A is a diagram showing an experimental procedure to evaluate reproducibility of liquid transfer from a transfer chip to a rapid calibration chip.

FIG. 8B shows chromatograms of caffeine (195.1/138.0, solid line) and an internal standard caffeine-d⁹ (204.1/144.1, dashed line) measured on the transfer (upper panel) and rapid calibration (lower panel) chips of FIG. 8A.

FIG. 8C shows plots of calculated volumes of liquid averaged for each SET diameter, wherein liquid that remained on the transfer chip is shown in the upper panel and liquid that was transferred to the rapid calibration chip is shown in the lower panel.

FIG. 8D is a chart showing errors and uncertainties at each step of using an RCC and a transfer chip, and illustrating liquid transfers between an RCC and a transfer chip.

FIG. 9A is a chromatogram of caffeine (solid line) and caffeine-d⁹ (dashed line) of a transfer chip that was used to deliver an internal standard to a rapid calibration chip.

FIG. 9B is a chromatogram of caffeine (solid line) and caffeine-d⁹ (dashed line) of a rapid calibration chip that was dipped in caffeine and then exposed to the transfer chip to deliver the internal standard.

FIG. 9C is a plot showing calculated volumes of liquid on the rapid calibration chip.

FIG. 10 is a plot comparing calibration curves that were obtained by solutions with different concentrations that were manually prepared and pipetted on a surface (dashed line) to a calibration curve obtained by using a rapid calibration chip and a transfer chip (solid line) according to one embodiment.

### DETAILED DESCRIPTION OF EMBODIMENTS

For quantitative analysis by methods such as mass spectrometry (e.g., electrospray ionization mass spectrometry (ESI-MS), matrix-assisted laser desorption/ionization (MALDI), desorption electrospray ionization (DESI)), spectroscopy (e.g. UV, fluorescence, visible (VIS), Raman), electrochemical techniques, elemental analysis (e.g., inductively coupled plasma mass spectrometry (ICP-MS)), the preparation of calibration solutions and their measurement before experimental runs are required for calibration of the quantitative analysis instrument. Described herein are apparatus and methods that simplify and significantly reduce the amount of effort and time required for calibration. Embodiments are based on a rapid calibration chip that uses fast and reproducible wetting behavior of hydrophobic/hydrophilic patterned surfaces to confine a series of differently sized droplets of a solution, such as a calibration solution or a standard solution on a substrate. A series of differently sized droplets of a calibration solution can be sampled with the instrument to obtain a calibration curve. Multiple series of droplets can be formed within seconds by dipping a rapid calibration chip into a calibration solution. No pipetting or sequential droplet deposition is required.

Control of the size and shape of the wetted areas, referred to herein as surface energy traps (SETs), on a calibration chip enables the spontaneous generation of differently-sized droplets upon dipping the chip in a solution and removing it from the solution (or otherwise providing solution and removing excess solution). The use of surface energy traps (SETs) provides rapid metering of calibrant solutions as droplets that can then be read by the instrument. In this way one can rapidly calibrate the instrument without traditional time-consuming and tedious fluid handling (e.g., pipetting) and standard solution preparation.

Embodiments described herein are based on a rapid surface directed wetting approach that does not require traditional calibrant volume/mass-based standard fractionation. Embodiments utilize discontinuous de-wetting to rapidly generate droplets on surfaces with precise volume control, wherein hydrophilic areas are surrounded by hydrophobic barriers forming SETs. SETs spontaneously fill with solution when immersed in a liquid or contacted by a droplet dragged across the patterned surface. No manual dispensing (e.g., pipetting) is required as liquid droplets adhere to the high surface energy regions, the volume of which is controlled by the wettability, size, and shape of the SETs, and droplets are easily accessible due to the open design. A series of differently sized and shaped SETs may be used to precisely capture calibration solution in only seconds. Surface patterning directs both the location and volume of droplets, and as a result, manual liquid handling is minimized, and the need to prepare multiple calibration solutions with different concentrations is eliminated. Instead, only a single calibrant solution is required to generate a standard calibration array. The high surface energy regions may be fabricated by techniques such as, but not limited to, laser ablation, plasma treatment, chemical etching, as well as others. For example, one fabrication approach may include using a picosecond laser microfabrication system to selectively remove a hydrophobic coating from a glass substrate exposing the hydrophilic glass beneath. Highly adhesive SETs may be created by removing a selectively-shaped area from the coated surface. For example, a circular area may be fully removed from the coated surface using a spiral milling approach. Alternatively, ring or other shapes or designs of SETs may be produced that reduce the adhesive nature of the SET and when combined with a sandwich transfer chip approach enable standard addition, with equal amount of internal standard solution applied to each calibration SET.

The performance of discontinuously de-wetting substrates, which may be referred to herein as rapid calibration chips (RCCs), to rapidly calibrate an instrument for quantitative analysis was evaluated with an ambient ionization mass spectrometry interface. A liquid microjunction-surface sampling probe (LMJ-SSP) extracts analytes from a surface using the direct contact of a liquid droplet, allowing analysis of a sample placed upon on a surface in a short time frame of only seconds. Briefly, pressurized liquid flows in the annular area of a tube surrounding two open-ended inner concentric tubes until it reaches the ends of the tubes where, due to the liquid surface tension, a liquid dome forms. The flow into the dome is balanced by an outward flow through the middle tube which is drawn by a vacuum (Venturi induced) which terminates in the ion source of the mass spectrometer where the sample is electrosprayed. Analyte that is placed into or contacted with the liquid dome is delivered to the MS as a discrete sample within seconds. The surface sampling characteristics of the LMJ-SSP make it suitable for demonstrating the capability of rapid calibration chips. RCCs and transfer chips as described herein may of course be used to calibrate other types of instruments in quantitative analysis techniques such as, but not limited to, spectroscopy and electrochemical techniques, examples of which were mentioned above.

As described below, an open port interface (OPI) probe (i.e., LMJ-SSP) configured for rapid manual or automated (programmable) 3-D movement was used to sample the SETs of a rapid calibration chip (RCC). The OPI probe/RCC calibration was assessed and compared to a traditional solution approach. Reproducibility and wetting behaviour as well as the effect of probe solvation flow rate on the surface sampling behavior of the OPI were investigated. An optimized OPI flow program was used to sample caffeine from SETs that had been discontinuously de-wetted showing near quantitative analyte removal from the SETs. A sandwich chip approach was used to deliver a similar volume of internal standard (caffeine-d⁹) to each SET by modifying the shape (adhesive force) of the SETs. Although the rapid calibration chip approach is demonstrated herein when combined with ambient ionization mass spectrometry, the approach may also be used in other analysis workflows based on spectroscopic and electrochemical detection schemes.

The invention will be further described by way of the following non-limiting examples.

### Examples

The following are examples describing fabrication, evaluation, and use of a rapid calibration and transfer chips.

All solvents were analytical grade and purchased from Sigma (St. Louis, MO, USA). Caffeine was obtained from Sigma (St. Louis, MO) and caffeine-d⁹ from CDN Isotopes (Point-Claire, Canada). Rapid calibration and transfer chips were fabricated with glass microscope slides (1″×3″, Fisher Scientific) as substrates that were dip-coated with a hydrophobic coating (Aculon™, San Diego, CA, USA). All aqueous standards were prepared with deionized water (>18.2 MΩ resistivity). A mass spectrometer (SCIEX Triple Quad 4500 (Sciex LLC, Framingham, MA, USA) equipped with a research prototype liquid microjunction-surface sampling probe (LMJ-SSP) was used for all measurements.

### Laser Micromachining for SET Patterning

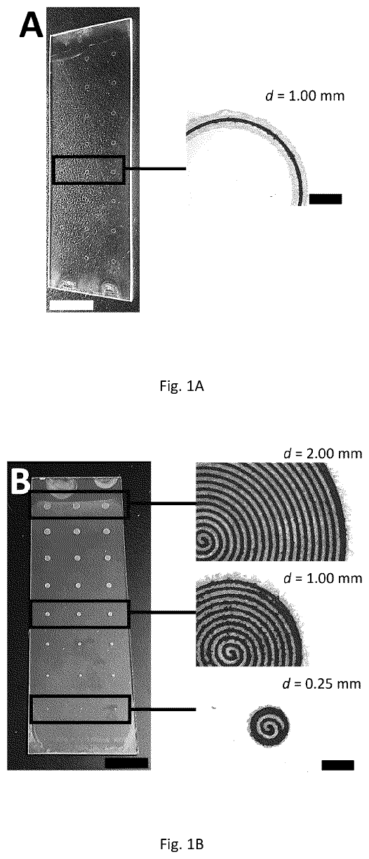

Glass microscope slides were rinsed with ethanol and cleaned by exposure to an air plasma before further treatment. The hydrophobic coating was applied by dipping a glass slide in a reservoir of Aculon™ AL-A and withdrawn at a rate of 4 cm/min followed by drying for 5 min at 100° C. Subsequently, the slide was allowed to cool to room temperature, dipped in a reservoir of Aculon™ A, and withdrawn at a rate of 4 cm/min followed by drying for 5 min at 100° C. An Oxford Lasers A Series (Oxford Lasers, Inc., Shirley, MA, USA) compact micromachining system equipped with a 355 nm solid-state diode-pumped picosecond-pulsed laser was used to precisely remove regions of the hydrophobic coating from glass substrates to form SETs by manipulating the laser in a desired pattern (circular, spiral pattern, etc.) over the slide surface. For spiral patterns, the distance between adjacent paths (i.e., pitch) of the spiral was set to a selected distance (e.g., 50 μm) (FIG. 1A).

For initial evaluation, each rapid calibration chip included three rows of different sized SETs. Each row had eight SETs with diameters of 0.25, 0.50, 0.75, 1.00, 1.25, 1.50, 1.75, and 2.00 mm (FIG. 1B). The center-to-center distance between the different sized SETs was maintained at 8 mm to allow facile interrogation with the LMJ-SSP and co-registration with internal standard transfer chips. The transfer chips were created to enable standard additions to be carried out. The transfer chips had the same number of SETs as the RCCs with their centers aligned with those on the RCC to ensure that the SETs of both slides were aligned when sandwiched. All SETs of the transfer chips had the same diameter and unlike the SETs of the RCC, the SETs of the transfer chip were fabricated by a single circular laser pass (FIG. 1A) so that the SETs were rings (e.g., diameter of 1.00 mm and an ablated width of 21.9±1.47 μm). SETs of the RCC were wetted and captured different volumes of a single concentration standard according to their different sizes, to rapidly produce a calibration slide for the LMJ-SSP. The same-size single ring SETs of the transfer chip captured same-size droplets through discontinuous dewetting, and facilitated droplet transfer when contacted with the SETs of the RCC. Of course other layouts of RCCs and transfer chips and other configurations of SETs may be used as may be appropriate for a given application.

### Mass Spectrometry, LMJ-SSP (OPI) Operation

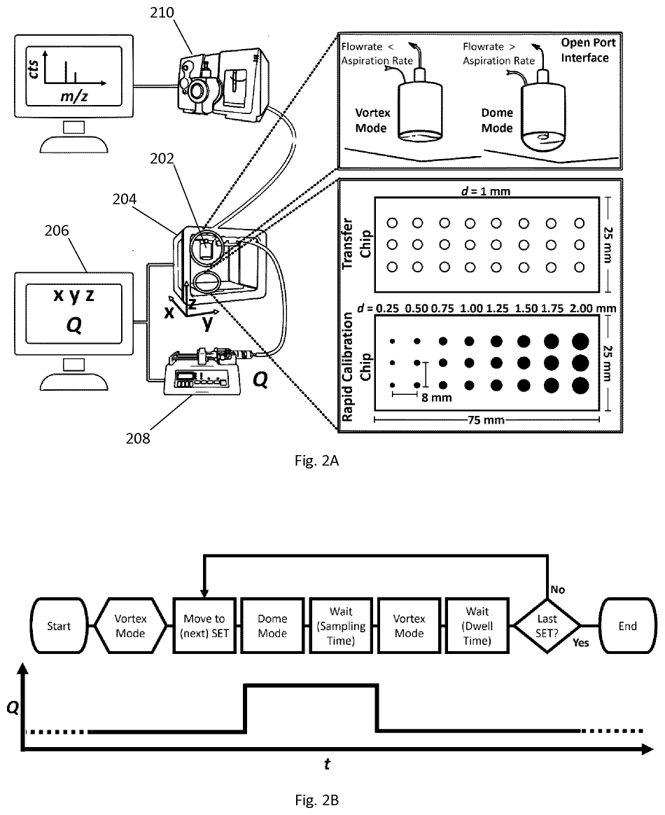

FIG. 2A is a diagram showing an experimental setup used for testing rapid calibration and transfer chips. The LMJ-SSP was a modified LMJ-SSP that enabled the analyte to be directly inserted, or introduced through solvent contact/extraction with a surface. Referring to FIG. 2A, the LMJ-SSP 202 was mounted on an apparatus 204 that allowed precise programmable computer-controlled movement of the probe in three axes (x, y, z). For the apparatus 204, the printer head of a 3D printer (Prusa i3-MK3, Prague, Czech Republic) was modified and used to hold and move the LMJ-SSP probe 202 relative to a RCC (or sample) placed on the printing bed. A 3D printer was used as it presented an apparatus that could conveniently be adapted to hold the probe 202 and control positioning of the probe relative to the RCC or sample using a computer 206 running computer numerical control (CNC) programming language such as G-code. Modifications included attaching a custom probe holder to the printer head to hold the probe in the correct position relative to the RCC/sample. A custom microcontroller based z-axis distance (i.e., distance above the RCC/sample surface) sensor was interfaced with the computer 206. G-code files were generated and sent to the apparatus 204 (3D printer) using a Python™ script (Python Software Foundation, version 3.7.0). Automation included movement along the z-axis according to a feedback loop, and movement along the x-axis and/or y-axis to control a sampling path, i.e., stepping of the probe across SET locations on an RCC, or sampling locations on a sample surface.

The LMJ-SSP 202 had two concentric tubes that were substantially coterminous at their distal ends (i.e., closest to the sample). The outer tube was made of stainless steel (OD=1.2 mm, ID=1 mm) and had a structure that accommodated the smaller inner tube made of polymer (polyetheretherketone, PEEK) (OD=0.8 mm, ID=0.25 mm). A desorption solvent (methanol:water:formic acid, 50:49.9:0.1 vol. %) was delivered into the space between the outer and inner tubes from a proximal end with a consistent flowrate Q using a syringe pump 208 (Fusion 100 Touch, Chemyx Inc., Stafford, TX, USA) controlled by the same computer 206. The inner tube was connected to a Venturi that draws liquid from the tip of the probe (i.e., liquid that has exited the outer tube). The liquid is then introduced to the mass spectrometer 210 through an electrospray interface.

The LMJ-SSP can be operated in two different modes that are dictated by the solvent flow to the LMJ-SSP and the aspiration rate of the solvent from the LMJ-SSP to the mass spectrometer (FIG. 2A top right). In vortex mode the solvent flow is lower than the aspiration rate, and the solvent does not accumulate at the tip of the sampling interface. This mode is not preferred for surface sampling since less solvent is available to wet the surface and extract analytes. In dome mode the solvent flow exceeds the aspiration rate, and the excess solvent is not delivered to the mass spectrometer and leads to an overflow of the sampling interface. Excess solvent enables the extraction of analytes from surfaces and makes the sampling process more robust to changes in probe/sample distance. A drawback of dome mode is that excess solvent could be left behind at the sample surface causing potential analyte loss.

Thus, programmed movement of the LMJ-SSP probe may be based on inputs such as the starting position (x, y, z), the center to center distance between SETs, the number of SETs, the sampling time, and the dwell time. Matched with the movement of the LMJ-SSP, the software also communicates with the syringe pump and changes the flow rate Q of the solvent for vortex and dome mode. FIG. 2B shows an example of a sampling sequence. The LMJ-SSP is set to vortex mode (low flow rate Q) and positioned above the first sampling spot. Following that the LMJ-SSP switches to dome mode (high flow rate Q) and remains in this mode for the sampling time. Once the sampling time is complete, the LMJ-SSP switches back to vortex mode for the dwell time before moving to the next SET where the sequence is repeated.

The flow conditions for sampling surfaces with the LMJ-SSP were optimized by combining the advantages of both modes (vortex and dome) using a flow program matched with the position of the LMJ-SSP. For example, in one embodiment based on FIG. 2B, for a sequence of steps for the flow optimization program the aspiration rate was kept constant and the solvent flow rate was set to 80 and 150 μL/min to switch the operation mode of the LMJ-SSP from vortex to dome mode, respectively. The LMJ-SSP was initially positioned 400 μm above a SET, in vortex mode, leaving a gap between the LMJ-SSP and the surface. The LMJ-SSP was then switched to dome mode for 15 s (sampling time) where the excess solvent bridged the gap between the LMJ-SSP and the surface and extracted the analyte. The excess solvent remained confined to the SET on the RCC due to the hydrophobic properties of the coating. After the 15 s sampling time, the LMJ-SSP switched to vortex mode for 30 s (dwell time) allowing the overflowed solvent to be delivered to the mass spectrometer. The LMJ-SSP then moved to the next SET where the sequence was repeated.

Mass spectra were recorded in multiple reaction monitoring mode (MRM) for caffeine (195.1/138.0 Da) and caffeine-d⁹ (204.1/144.1 Da) and positive ion (scanning) mode.

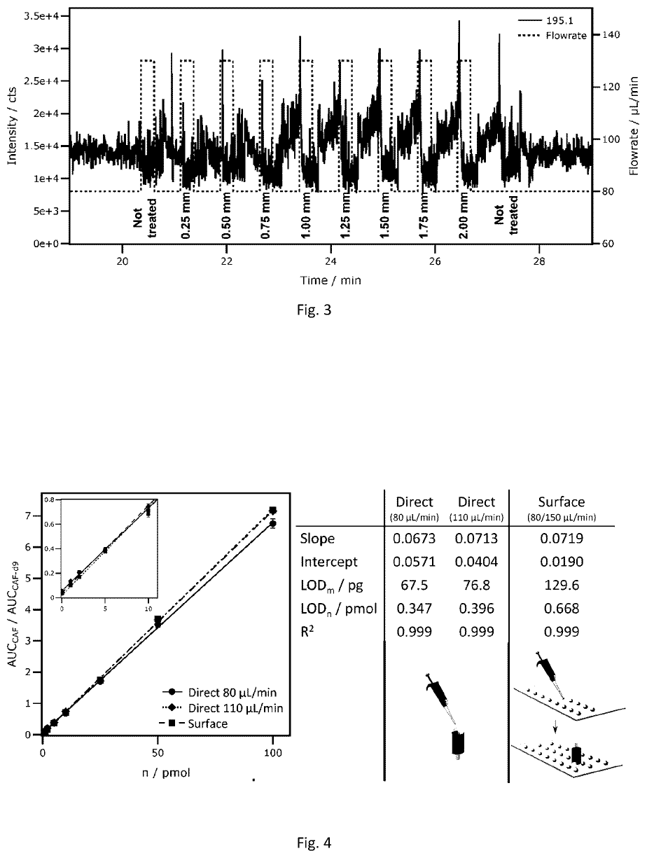

Switching the LMJ-SSP between vortex and dome mode leads to changes in the solvent volume that is delivered to the mass spectrometer. The impact of these flow changes on the measured signal intensity was investigated by sampling an empty (blank) row of calibration SETs. FIG. 3 shows the obtained signal intensities for the transition of caffeine (m/z: 195.1/138.0, solid line) together with the flowrate (dashed line). It can be seen that the fluctuations in the signal intensity follow the periodicity of the flowrate changes. Whether the LMJ-SSP sampled a SET (SET diameter) or an area that was not treated is indicated along the x-axis. The size of the SET that was sampled has an impact on the solvent flow at the interface. A large SET leads to increased wetting of the surface and therefore more solvent leaving the LMJ-SSP. When a smaller SET or no SET is sampled the solvent is more strongly repelled by the surface (due to the smaller hydrophilic surface area). Less solvent leaves the sampling interface to wet the surface leading to a lower impact on the flow and the resulting signal.

### Analyte Extraction Efficiency on SETs Using a LMJ-SSP

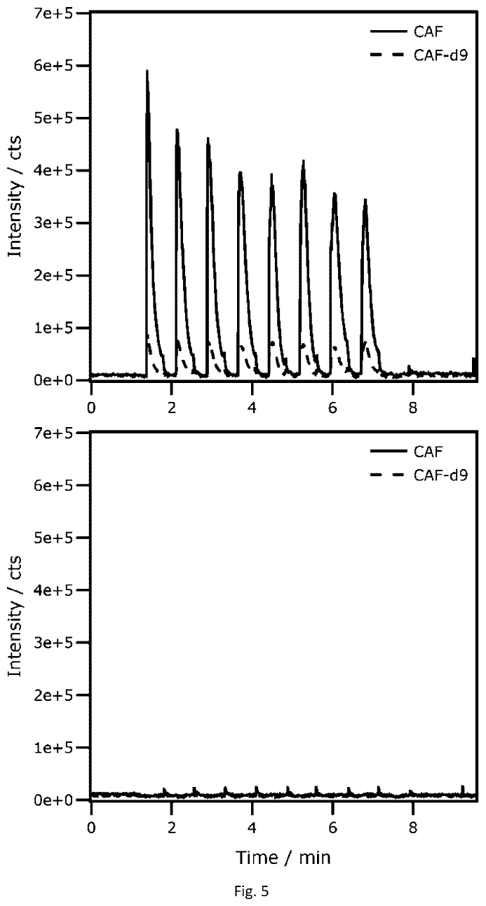

The accuracy of rapid calibration chips for generating calibration curves depends on the reproducibility of liquid volumes deposited on surface energy traps of given diameters by discontinuous dewetting. When contacting the LMJ-SSP to the SETs there is potential sample/sensitivity loss from incomplete sampling of the entire SET, insufficient time for analyte transfer, solubilization, or dilution. Sampling efficiency was determined to confirm that analytes deposited and dried on hydrophilic SETs are quantitatively extracted and delivered to the mass spectrometer by sampling them with the LMJ-SSP. Before using discontinuous dewetting for fast deposition of analyte on SETs, the calibration solutions were manually prepared (Table 1), pipetted on three differently sized SETs (0.50, 1.25, and 2.00 mm) of a rapid calibration chip, dried, and then sampled with the LMJ-SSP. Based on these results a surface sampling calibration curve (FIG. 4, dashed line) was obtained that was compared to reference calibration curves (FIG. 4, solid and dotted lines). For the reference calibration curves, the solutions were directly pipetted into the LMJ-SSP and therefore no analyte loss would occur from surface/extraction effects.

TABLE 1
Manually prepared calibration solutions for caffeine
with caffeine-d⁹ as an internal standard.

| | |
|---|---|
| Caffeine (CAF) | Caffeine-d⁹ (CAF-d⁹) |

| # | Vₜₒₜₐₗ/μL | c/μM | n/pmol | c/μM | n/pmol |
|---|---|---|---|---|---|
| 1 | 1 | 0 | 0 | 10 | 10 |
| 2 | 1 | 1 | 1 | 10 | 10 |
| 3 | 1 | 2 | 2 | 10 | 10 |
| 4 | 1 | 5 | 5 | 10 | 10 |
| 5 | 1 | 10 | 10 | 10 | 10 |
| 6 | 1 | 25 | 25 | 10 | 10 |
| 7 | 1 | 50 | 50 | 10 | 10 |
| 8 | 1 | 100 | 100 | 10 | 10 |

When comparing these sampling procedures a few differences need to be considered. In surface sampling mode, the opening of the LMJ-SSP was facing downwards however to facilitate direct pipetting of solutions into the LMJ-SSP its orientation was rotated by 180°. The upward-facing orientation of the LMJ-SSP and no surface contact involved in the direct pipetting mode required the probe to operated in vortex mode since the excess solvent in dome mode would cause the probe to overflow. Therefore, the calibration curves in direct sampling mode were obtained with constant probe flow rates of 80 and 110 μL/min (vortex mode), respectively. Calibration curves were based on five replicates and the limit of detection for each calibration curve was calculated by multiplying the standard deviation of its respective blank by three. The limit of detection for surface sampling was lower compared to direct pipetting, however, it was possible to achieve a limit of detection of 0.668 pmol (129.6 pg). Interestingly both direct sampling methods lead to different sensitivities which can be explained by the different solvent flow rates. The higher flow rate of 110 μL/min (FIG. 4, dotted line) leads to increased analyte dilution and lower sensitivity compared to a flow rate of 80 μL/min (FIG. 4, solid line). When sampling a SET the flow rate in dome mode is even higher at 150 μL/min (FIG. 4, dashed line) leading to a further decrease in sensitivity.

Another potential source of decreased sensitivity is incomplete extraction of the analyte on the surface. We carried out an experiment to confirm the lower sensitivity in surface sampling mode is due to sample dilution and not incomplete extraction from the surface of the SETs. The highest concentrated calibration solution (1 μL, 100 μM CAF, 10 μM CAF-d⁹) was deposited on all SETs of a series (d=0.25-2.00 mm) and sampled twice to ascertain if residual analyte could be detected in the second pass. FIG. 5 shows the chromatograms obtained (caffeine: 195.1/138.0, solid line and caffeine-d9: 204.1/144.1, dashed line) when a row of SETs was sampled the first time (right) and second time (left). FIG. 5 shows that neither the analyte caffeine nor the internal standard caffeine-d⁹ were detectable when the LMJ-SSP was contacted to SETs that had been previously sampled. Only low-intensity fluctuations (<3e⁵) can be seen which are attributed to changes in the flow rate (and background) vide supra (FIG. 3). Furthermore, FIG. 5 shows that the peak shape in the total ion chromatogram changes depending on the size of the SET even when the same amount of analyte is deposited on each SET. Generally smaller SETs lead to higher and narrower peaks while larger SETs lead to wider and shorter peaks. For smaller SETs, the same amount of analyte dries down on a smaller area and is, therefore, faster desorbed by the open port interface leading to a narrower peak with a lower full width at half maximum (FWHM=9.5 s for 0.25 mm SET). For larger SETs, the same amount of analyte is distributed across a larger area which takes longer to be wetted and desorbed leading to a wider peak (FWHM=13.2 s for 2.00 mm SET). As a result, the area under the curve rather than peak height was used to quantify the amount of analyte detected.

Overall, these results confirm that an LMJ-SSP can efficiently sample analyte that is deposited on SETs, that signal loss compared to directly inserted samples is attributed to probe flowrate, and SET dimensions impact signal intensity and peak width necessitating peak integration.

### Evaluation of Reproducibility of Discontinuous Dewetting of Rapid Calibration Chips

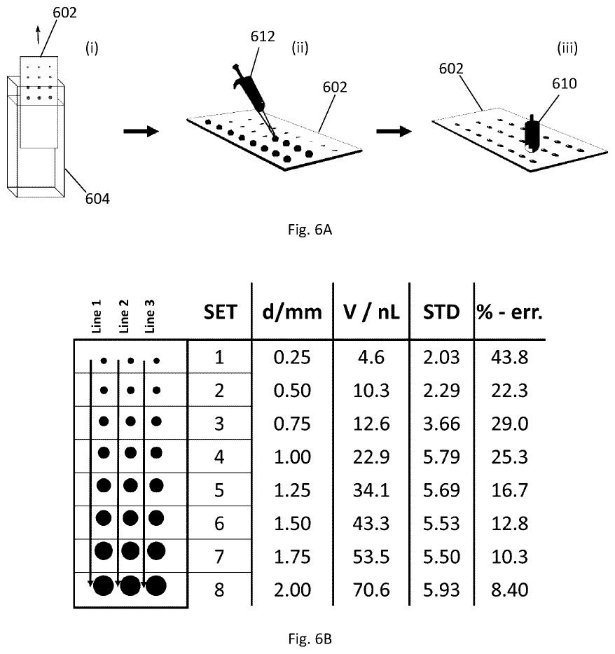

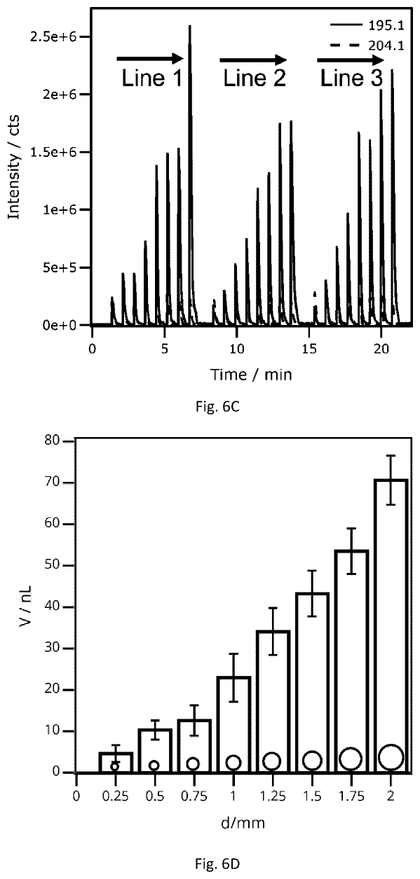

FIG. 6A shows an embodiment of a rapid calibration chip 602 with three rows of eight SETs. In one embodiment the SETs in each row ranged from 0.25 to 2.00 mm diameter in 250 μm increments. These SETs were designed to spontaneously meter 5-70 nL which corresponds to 2-35 pmol of analyte when using a 500 μM solution and 8-140 pmol of analyte when using a 2 mM solution. Rapid calibration chips based on this pattern were immersed in aqueous caffeine solutions 604 (0.5 or 2 mM) and subsequently vertically pulled from the solution leading to different sized droplets remaining on the pattern of SETs, as shown in FIG. 6A, step (i). After approximately 5 min at room temperature, when the droplets had dried, the internal standard was manually pipetted 612 onto each SET (1 μL of 10 μM caffeine-d⁹, FIG. 6A, step (ii)), and allowed to dry. Using the LMJ-SSP 610, the three rows of SETs were sampled (FIG. 6A, step (iii)) from the smallest (d=0.25 mm) to the largest (d=2.00 mm) SET (shown diagrammatically in FIG. 6B, left, arrows). Extracted ion chromatograms (FIG. 6C) show intensities of caffeine (195.1/138.0, solid line) and the internal standard caffeine-d⁹ (204.1/144.1, dashed line) for the 2 mM caffeine solution. Using the calibration curve (FIG. 4, dashed line), the droplet volumes deposited on each SET were estimated as shown in FIG. 6D, where error bars are based on triplicate measurements on each rapid calibration chip. The table in FIG. 6B provides the calculated average volumes for each SET diameter. Based on triplicates, the absolute standard deviation of the deposited volumes is lower for small SET diameters (0.25, 0.75, and 1.00 mm) and the volume plateaus≈5.5 nL for SET diameters of ≥1.00 mm. This leads to lower relative standard deviations for larger SET diameters. For the largest SET with a diameter of 2.00 mm, a relative error of 8.4% was obtained. Air displacement micropipettes can achieve accuracies below 1% when volumes above 200 μL are handled. But for lower volumes, the allowed error to fulfill DIN 12650 requirements for variable volume pipettes increases up to 15% for a volume of 1 μL and are not recommended for handling volumes below that. Suitable techniques for picolitre and nanolitre liquid handling are inkjet and acoustic droplet ejection which can both achieve errors below 5% but are significantly more expensive than chips utilizing discontinuous dewetting.

### Sandwiched SET Patterned Chips for Droplet Transfer

A single discontinuous de-wetting step can be used to precisely position and meter individual analyte droplets on a patterned RCC. Further fluid addition steps may be necessary for sample preparation or in particular, standard addition. In standard addition, the same amount of analyte is added to every sample to minimize and monitor matrix effects. This can be accomplished by individually pipetting the appropriate amounts onto each SET (e.g., FIG. 6A, step (ii)), however, the gains in simplicity and speed associated with the rapid calibration chip are somewhat negated. Instead, a sandwich approach that employs a patterned transfer chip (FIGS. 1A, 2A) based on the same principle as the rapid calibration chip may be used.

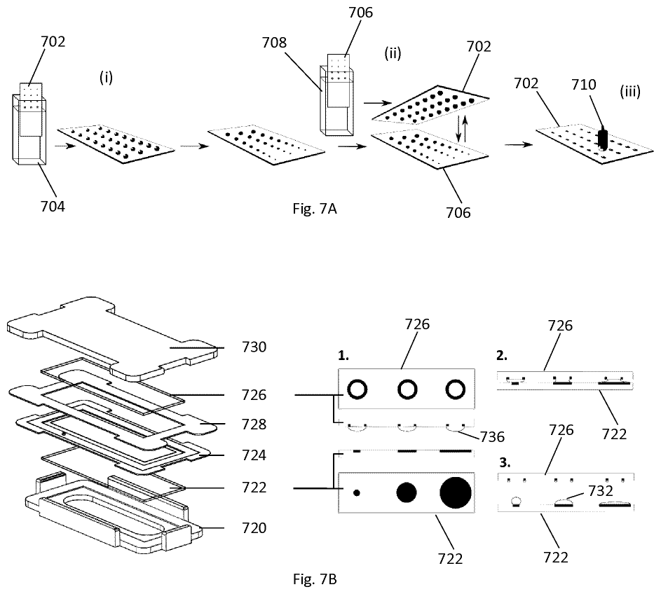

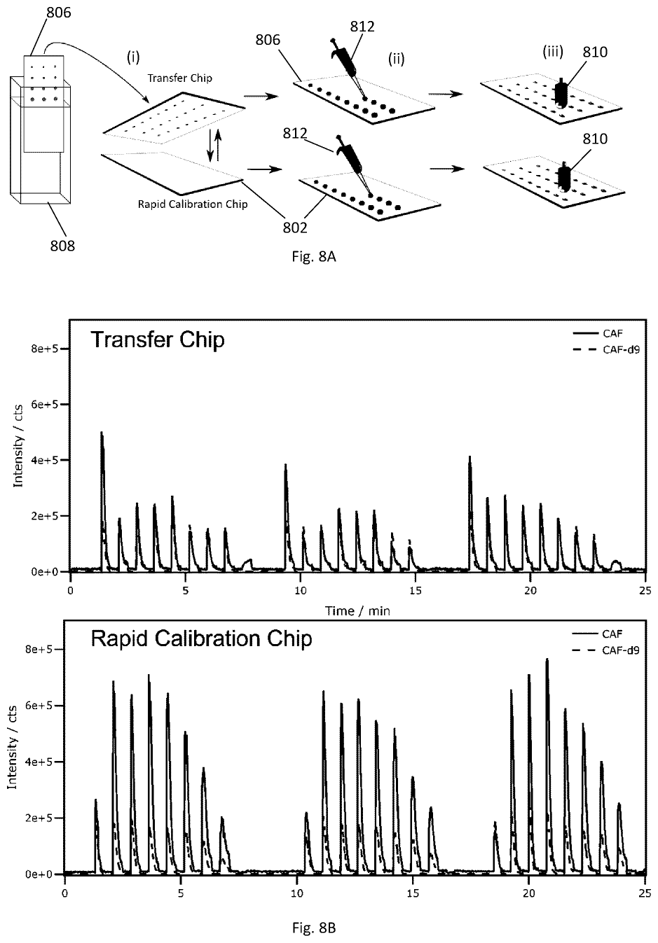

An example of a procedure and apparatus for sample deposition using a rapid calibration chip followed by internal standard deposition using a transfer chip is shown in FIGS. 7A and 7B. Referring to FIG. 7A, step (i), a rapid calibration chip 702 (e.g., with three rows of eight different sized SETs) is dipped in a sample solution 704 leading to the formation of three rows of differently sized droplets. At step (ii) a transfer chip 706 with a pattern of SETs designed to align with the SETs of the RCC when the two are sandwiched face-to-face is dipped in a solution of internal standard 708 and the RCC and the transfer chip are sandwiched together. The sandwiching of the chips is typically done after the droplets on the RCC are dry, and while the droplets on the transfer chip are still wet, since droplets on the transfer chip need to be wet in order to allow transfer. Drying the droplets on the RCC before contact with the transfer chip reduces the amount of sample being transferred to the transfer chip, and may not be necessary but improves reproducibility. After separating the chips, at (iii) each SET of the RCC 702 is sampled by the LMJ-SSP 710. For example, the optimized flow program discussed above with reference to FIG. 2B may be used.

In the above procedure, typically the droplets on the RCC are allowed to dry prior to sampling. Although this is not essential, it provides better calibration since sampling the droplets while wet would result in unpredictable volume transfer and analyte mixing (e.g., through diffusion).

FIG. 7B is a diagram illustrating an embodiment of a RCC 722 and transfer chip 726, together with associated components, and a method of use. For simplicity, only three SETs are shown on each chip. As shown at the left, a rapid calibration chip 722 is placed into a chip holder 720 and then a frame 724 comprising a spacer is placed on the RCC. The spacer is design to ensure a selected consistent spacing is maintained between the RCC 722 and the transfer chip 726 during sandwiching, e.g., a spacing of about 50 μm. The spacer may be made from a material such as Teflon®. A transfer chip holder 728 is then placed on the spacer to align the transfer chip 726 with the RCC 722, and then both chips are brought in contact by placing a stamping lid 730 on top and pushing down, thereby applying sufficient pressure to ensure the RCC and transfer chip are fully seated in the holders and against the spacer so that liquid transfer occurs. In the center of FIG. 7B, at 1, plan and side views of the transfer chip and RCC are shown, with droplets 736 on the SETS of the transfer chip 726. In this embodiment the transfer chip 726 has ring-shaped SETs, and the RCC 722 has SETs that are designed to improve liquid transfer from the transfer chip to the RCC, such as, e.g., a spiral design. These sets may be produced by, e.g., ablation using a spiral ablation path. At the right of FIG. 7B, at 2, a side view of the sandwiched transfer chip and RCC is shown wherein they are disposed face to face with a selected spacing between them such that the droplets bridge the space, and at 3, the transfer chip and RCC are separated leaving droplets 732 on the SETS of the RCC 722.

From the above and FIG. 7B, 2, it can be seen that droplets from the transfer chip bridge contact the SETs of the rapid calibration chip, and at FIG. 7B, 3, a reproducible portion of the transfer chip droplets are delivered to the SETs of the RCC once the chips are separated. The size and shape of the SETs can be designed to adjust the droplet volume delivered and also the adhesive force exerted by the droplet on the surface. In this case it is desirable to transfer as much of the liquid as possible from the transfer chip to the rapid calibration chip. To maximize liquid transfer to the rapid calibration chip, the SETs of the transfer chip were laser machined to be ring-shaped (e.g., a laser pass with a width of 21.9 μm forming a circle with a diameter of 1 mm) hydrophilic areas, unlike the SETs having a spiral laser ablation path of the rapid calibration chip.

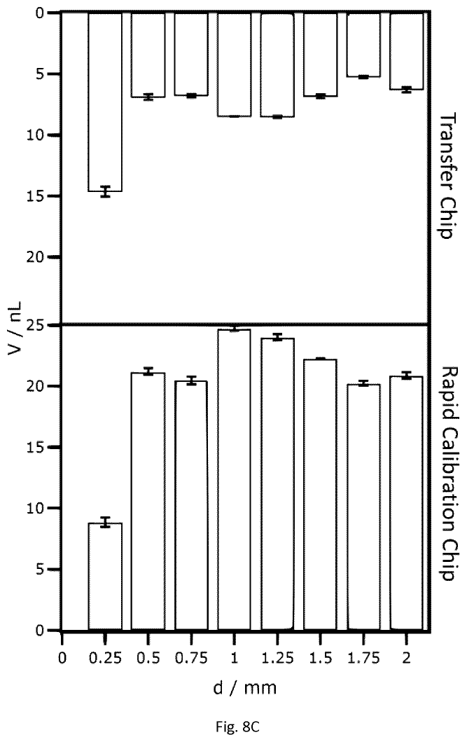

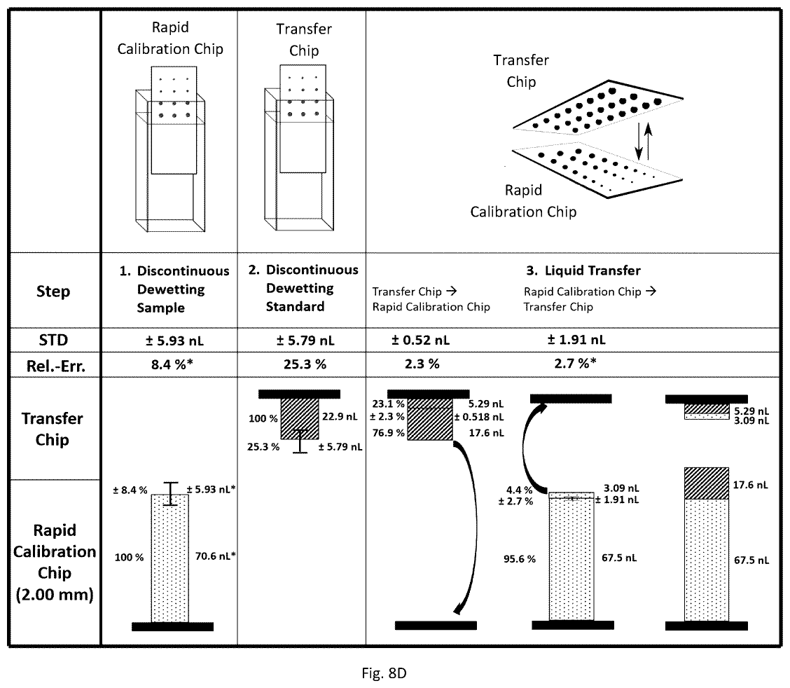

The reproducibility of delivering consistent amounts of internal standard on SETs of rapid calibration chips with transfer chips using a sandwich chip approach was first tested on empty rapid calibration chips (i.e., not previously wetted). As shown in FIG. 8A, step (i) a transfer chip 806 was immersed in a caffeine solution 808 and immediately after removing the slide from the solution it was sandwiched against an empty rapid calibration chip 802 using a 3D printed frame such as that shown in FIG. 7B. After 5 seconds the chips were separated. The RCC had a SET pattern as described above, three rows of different sized SETs, each row had eight SETs with diameters of 0.25, 0.50, 0.75, 1.00, 1.25, 1.50, 1.75, and 2.00 mm. At step (ii), once the droplets on both chips were dry an internal standard (1 μL of 10 μM caffeine-d⁹) was pipetted 812 on each SET of both the transfer chip and the rapid calibration chip, and the chips were sampled using the LMJ-SSP 810. Using the previously obtained calibration curve (FIG. 4) the volume of caffeine solution that was transferred to the rapid calibration chip and that remaining on the transfer chip was calculated. FIG. 8B shows the chromatograms obtained for caffeine (195.1/138.0, solid line) and the internal standard caffeine-d9 (204.1/144.1, dashed line) measured on the transfer chip and the rapid calibration chip. The three rows of SETs (diameters from 0.25 to 2.00 mm) were sampled leading to 24 peaks. FIG. 8C shows the calculated average volumes of liquid that remained on the transfer chip and the rapid calibration chip for each SET size. A small amount of analyte was left behind on the transfer chip, but for SET diameters of 0.50 mm and larger the amount of liquid transferred to the rapid calibration chip was consistent and reproducible with an error of 10.7%. The liquid deposition process is a balance of adhesive forces exerted by SETs on the transfer and rapid calibration chips. A ring-shaped SET allows a larger wetting diameter and thus larger deposited volume when discontinuously dewetted while reducing droplet adhesion. The smallest SET size (0.25 mm) of the rapid calibration chip results in a smaller adhesive force than the transfer chip and less of the transfer chip droplet volume is delivered. This is reflected in the results of the analyte present on the transfer chip after contact with the rapid calibration chip. The caffeine concentration on each of the ring-shaped SETs is similar except for the SET aligned with the smallest SET (0.25 mm) of the RCC, which exhibits a higher caffeine concentration. This is again a direct result of the larger adhesive force of the transfer chip ring SET compared to the smallest circular-shaped SET of the rapid calibration chip. In other embodiments, ablating more of the hydrophobic coating (e.g., by using a higher laser power) of smaller SETs, and/or using a different SET design for smaller SETs, may be used to adjust adhesive forces and mitigate differences in liquid transfer among different sized SETs.

### Combining Rapid Calibration Chip and Transfer Chip

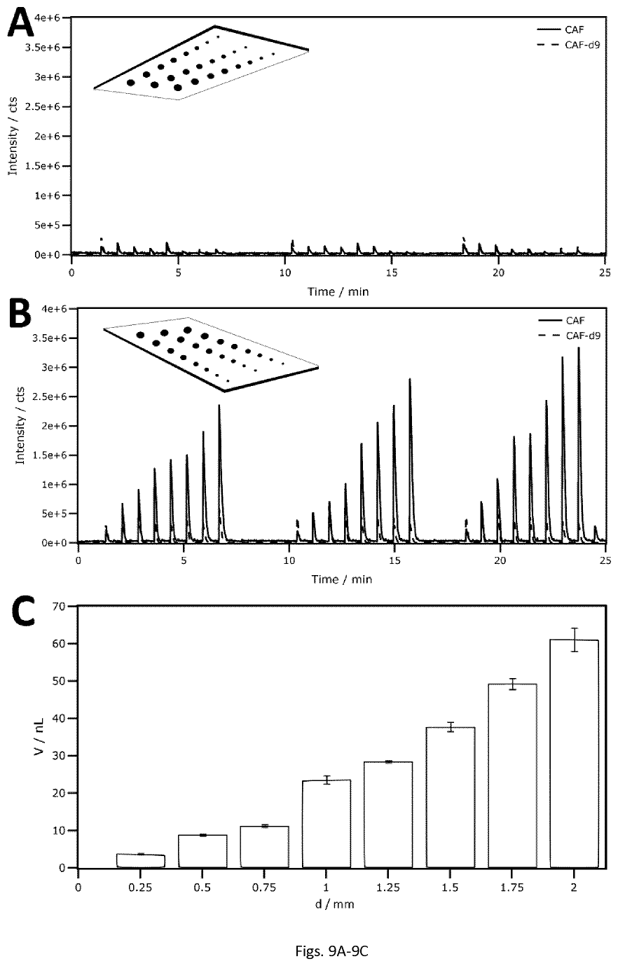

After establishing the reproducibility of depositing different volumes of samples to SETs of rapid calibration chips and delivering consistent volumes of internal standard from a transfer chip to a rapid calibration chip, both steps were combined using an apparatus such as that shown in FIG. 7B. A rapid calibration chip having three rows of eight SETs ablated in a spiral pattern with diameters of 0.25, 0.50, 0.75, 1.00, 1.25, 1.50, 1.75, and 2.00 mm was dipped in caffeine solution (500 μM) and placed in the RCC holder. The droplets were allowed to dry (5 min), then a transfer slide having ring-shaped SETs (1 mm diameter) was dipped in a solution containing the internal standard caffeine-d⁹ (500 μM) and was immediately sandwiched with the rapid calibration chip by placing it into the transfer chip holder. After 5 seconds the slides were separated, and the droplets were allowed to dry (2 min) before analyzing each SET with the open port interface. FIGS. 9A and 9B show the chromatograms obtained for caffeine (solid line) and caffeine-d⁹ (dashed line) for the transfer chip and the rapid calibration chip, respectively. FIG. 9C shows the calculated volumes of caffeine picked up by the rapid calibration chip.

As previously discussed with respect to FIG. 8C, even though the SETs of the transfer chip may be ring-shaped to minimize droplet adhesion and to maximize liquid transfer to the rapid calibration chip, some liquid is left behind on the transfer chip (e.g., 5.29±0.52 nL, see FIG. 8D: 3. Liquid Transfer, Transfer Chip→Rapid Calibration Chip). The dashed line in FIG. 8B shows the expected residual caffeine-d⁹ on the transfer chip according to FIG. 8C where a larger amount is left on the transfer chip when it is sandwiched against the smallest SET (0.25 mm dia.) of the rapid calibration chip. Interestingly, caffeine (solid line in FIG. 8B) was also detected on the transfer slide meaning that during sandwiching some caffeine that was deposited and evaporated on the calibration chip was redissolved by the caffeine-d⁹ solution droplets and transferred to the transfer chip during sandwiching. In this embodiment the average amount of caffeine that was transferred from the rapid calibration chip to the transfer chip corresponds to a volume of 3.09±1.91 nL (FIG. 8D: 3. Liquid Transfer, Rapid Calibration Chip→Transfer Chip) for each SET diameter and needs to be considered when a calibration curve is calculated. Variations in analyte transfer from the rapid calibration chip to the transfer chip were minimized by keeping the contact time during sandwiching (e.g., 5 s) consistent. Considering the uncertainties of each step (σₙ) an error propagation calculation was performed to determine the overall standard deviation σₜₒₜₐₗ for each calibration point, which was determined to be 8.45 nL. In FIG. 8D the transferred volumes and standard deviations for each step are shown based on a 2.00 mm dia. rapid calibration chip SET.

### Rapid Calibration Curve

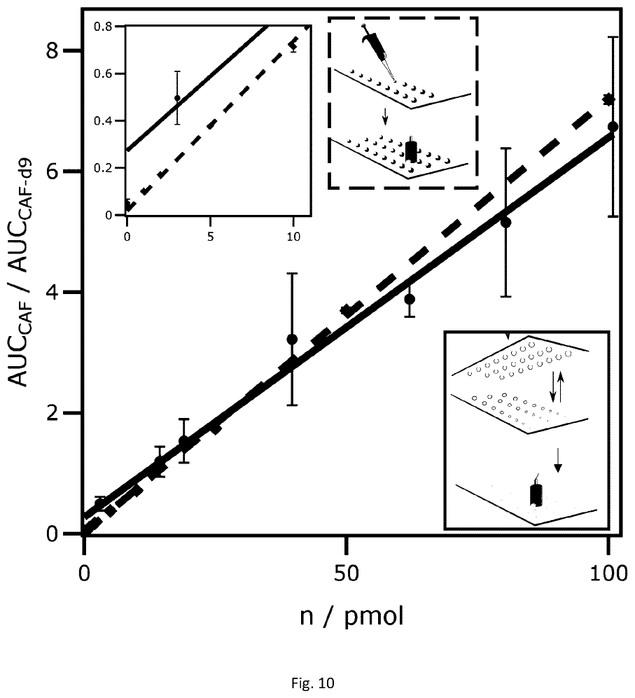

Using discontinuous dewetting of a sample (e.g., caffeine, 2 mM) on a rapid calibrationchip, and an internal standard on the transfer chip, (e.g., caffeine-d9) followed by a liquid transfer using a sandwich chip approach, a calibration curve was obtained from the ground up. FIG. 10 shows the calibration curve (solid line) compared to the previously shown (i.e., FIG. 4) calibration curve (dashed line) that was obtained by sampling dried droplets that were manually prepared by direct pipetting on a chip. Also, the resulting limit of detection (LOD) of 0.735 pmol (FIG. 10, inset) is about 10% higher for the rapid calibration chip than the LOD of the previous calibration curve due to the higher standard deviation of the blank sample. The difference in the calibration curve obtained by the RCC can be attributed to variations that are introduced at each step (see FIG. 8D). On the other hand, a calibration curve obtained with the RCC requires substantively less work and can be prepared within seconds. This allows one to improve the performance of the calibration by extending the number of differently sized SETs without the need for additional work and time.

### CONCLUSIONS

Discontinuous dewetting of hydrophobic/hydrophilic patterned surfaces is a rapid, reproducible, easy to use, and cost-effective technique to precisely deposit small liquid volumes in the range of nano liters on surfaces. As described herein, discontinuous dewetting can be used for the calibration of instruments for quantitative analysis. As the formation of droplets on such substrates is rapid and achieved by simple procedures such as dipping a chip into one calibration solution, the calibration process is both accelerated and simplified. Furthermore, as described herein, embodiments comprising a combination of a rapid calibration chip with differently sized SETs together with a transfer chip with same-sized SETs allows for the addition of an internal standard to samples that were previously deposited on a rapid calibration chip. Depending on the required concentration range and accuracy of the calibration, the number and the range of differently sized SETs can be adjusted. Droplet deposition by discontinuous dewetting takes seconds and the required time is independent of the number of SETs. Applications include calibration of quantitative analysis instruments (e.g., triple quad mass spectrometer, and the same approach can be applied to calibrate other instruments such as point-of-care devices.

All cited publications are incorporated herein by reference in their entirety.

### EQUIVALENTS

It will be appreciated that modifications may be made to the embodiments described herein without departing from the scope of the invention. Accordingly, the invention should not be limited by the specific embodiments set forth, but should be given the broadest interpretation consistent with the teachings of the description as a whole.

1. A method for calibrating a quantitative analysis instrument, comprising:
providing a calibration chip surface having a plurality of different sized surface energy traps (SETs) formed thereon;
providing a transfer chip surface having a plurality of same sized SETs formed thereon;
wherein the SETs of the calibration chip surface and the SETs of the transfer chip surface are substantially aligned when the calibration chip surface and the transfer chip surface are disposed face to face;
exposing the calibration chip surface to a solution comprising an analyte such that different sized droplets adhere to the different sized SETs;
exposing the transfer chip surface to a standard solution such that same sized droplets adhere to the same sized SETs;
disposing the calibration chip and the transfer chip face to face in a spaced relationship such that the same sized droplets of the standard solution contact the SETs of the calibration chip and at least a portion of each droplet of the standard solution is transferred to the SETs of the calibration chip; and
separating the calibration chip and the transfer chip and using the calibration chip to calibrate the quantitative analysis instrument by sampling the SETs with the quantitative analysis instrument.

2. The method of claim 1, wherein adhesion of droplets to SETS of the transfer chip and transfer of at least a portion of standard solution to SETs of the calibration chip is controlled according to a selected shape of the SETs of the transfer chip.

3. The method of claim 1, comprising allowing the different sized droplets of the solution comprising the analyte to dry before aligning the calibration chip and the transfer chip.

4. The method of claim 1, wherein the quantitative analysis instrument is for mass spectrometry, spectroscopy, or an electrochemical technique.

5. The method of claim 1, wherein the quantitative analysis instrument is for mass spectrometry.

6. The method of claim 5, comprising sampling the SETs with a liquid microjunction-surface sampling probe (LMJ-SSP).

7. The method of claim 1, wherein the SETs of the calibration chip and the SETs of the transfer chip are defined by regions of a hydrophilic substrate surrounded by a hydrophobic coating disposed on the hydrophilic substrate.

8. The method of claim 1, wherein the SETs of the calibration chip comprise a shape that is circular or spiral.

9. The method of claim 1, wherein the SETs of the transfer chip comprise a shape that is circular or a ring.

10. The method of claim 1, comprising using an alignment tool to align the calibration chip and the transfer chip face to face in a spaced relationship.

11. The method of claim 10, wherein the alignment tool comprises a spacer that maintains the aligned calibration chip and the transfer chip face to face in the spaced relationship at a selected distance.

12. Apparatus for calibrating a quantitative analysis instrument, comprising:
a calibration chip having a calibration surface comprising a plurality of different sized surface energy traps (SETs) formed thereon;
a transfer chip having a transfer surface comprising a plurality of same sized SETs formed thereon;
wherein the SETs of the calibration chip and the SETs of the transfer chip are substantially aligned when the calibration surface and the transfer surface are disposed face to face; and
an alignment device that aligns the calibration chip and the transfer chip face to face in a spaced relationship such that material disposed on the SETs of the calibration surface contact droplets of a solution disposed on the SETs of the transfer surface.

13. The apparatus of claim 12, wherein the calibration chip is used to calibrate the quantitative analysis instrument by sampling the SETs of the calibration surface using the quantitative analysis instrument.

14. The apparatus of claim 12, wherein the quantitative analysis instrument is for mass spectrometry, spectroscopy, or an electrochemical technique.

15. The apparatus of claim 12, wherein the quantitative analysis instrument is a mass spectrometer.

16. The apparatus of claim 15, wherein the mass spectrometer comprises a liquid microjunction-surface sampling probe (LMJ-SSP).

17. The apparatus of claim 12, wherein the SETs of the calibration chip and the SETs of the transfer chip are defined by regions of a hydrophilic substrate surrounded by a hydrophobic coating disposed on the hydrophilic substrate.

18. The apparatus of claim 12, wherein the SETs of the calibration chip comprise a shape that is circular or spiral.

19. The apparatus of claim 12, wherein the SETs of the transfer chip comprise a shape that is circular or a ring.

20. The apparatus of claim 12, wherein the alignment device comprises a spacer that maintains the aligned calibration chip and the transfer chip face to face in the spaced relationship at a selected distance.
